(19) United States
(12) Patent Application Publication
(10) Pub. No.: US 2015/0331834 A1
(43) Pub. Date: Nov. 19, 2015

(54) Method and Apparatus for Fast Signal Processing

(71) Applicant: Mykhaylo Sabelkin, Fairborn, OH (US)

(72) Inventor: Mykhaylo Sabelkin, Fairborn, OH (US)

(21) Appl. No.: 14/809,707

(22) Filed: Jul. 27, 2015

Related U.S. Application Data
(62) Division of application No. 13/090,608, filed on Apr. 20, 2011.

(51) Int. Cl. G06F 17/14; H04L 1/20; H04L 25/02

(52) U.S. Cl. CPC G06F 17/14; H04L 25/0228; H04L 1/20

(57) ABSTRACT

A method and apparatus for fast signal processing is presented. Increase of traffic over data communication networks requires increase of data processing speed. The proposed method is faster than the conventional technique, because it uses less operations of multiplications and additions. The method implements a flexible algorithm architecture based on an elementary cell which is used for both direct and inverse transforms. The method can be implemented for fast analysis and synthesis of different signal types; for fast multiplexing and demultiplexing; and for channel estimation and modeling. The flexible architecture allows: 1) conducting signal analysis according to a certain criterion, and operating on the whole signal or it's part; 2) modifying multiplexed datastream number “on the fly”, splitting and merging groups of datastreams from different sources; 3) splitting a communication channel into a set of sub-channels of different bandwidth, organizing data communication in particular subchannels that satisfy certain requirement.

### CROSS-REFERENCE TO RELATED APPLICATIONS

### Related U.S. Application Data

This is a division of application Ser. No. 13/090,608, filed on Apr. 21, 2011

### Foreign Application Priority Data

May 03, 2010

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Traffic over data communication networks is increasing constantly. This fact requires data communication systems to increase data processing speed. Conventional signal processing techniques often fail to satisfy new requirements. The present invention is in the technical field of signal processing. More particularly, the present invention is in the technical field of signal analysis/synthesis, channel estimation/modeling, and data multiplexing/demultiplexing. The proposed signal processing method uses less operations of multiplications and additions, than the conventional signal processing technique does. Hence it is faster than the conventional technique such as a Fast Fourier Transform (FFT). The proposed method uses the same algorithm for direct and inverse transforms. Hence it requires less system resources compare to the conventional technique such as a pair of transforms: Fast Fourier Transform (FFT) and Inverse Fast Fourier Transform (IFFT). The proposed method uses a flexible algorithm architecture based on an elementary cell. This fact allows to adapt the algorithm structure to capabilities of platform it is deployed on. Also the flexible algorithm architecture allows to modify the algorithm structure “on the fly” without interrupting the processing.

### BRIEF SUMMARY OF THE INVENTION

The present invention is a method and apparatus for fast signal analysis/synthesis, channel estimation/modeling, and data multiplexing/demultiplexing. The proposed method can be implemented for fast analysis and synthesis of a one-dimensional (1D) signal, such as an audio signal, a voice, a control sequence; a two-dimensional (2D) signal, such as a grayscale image; a three dimensional signal (3D), such as a static 3D mesh or a color image; a four dimensional signal, such as a dynamic 3D mesh or a color video signal; and a five dimensional signal such as a stereo color video signal. The flexible algorithm architecture allows to conduct a signal analysis according to a certain criterion. Also the flexible algorithm architecture allows to operate on the whole signal or it's part. The proposed method can be implemented for fast multiplexing and demultiplexing of multiple datastreams. The flexible algorithm architecture allows to modify datastream number “on the fly” without interrupting the processing. Also the flexible algorithm architecture allows split and merge groups of datastreams from different sources. For example, the proposed method can be used to implement a multiple user access to a single communication channel. The proposed method can be implemented for communication channel estimation and modeling. The flexible algorithm architecture allows to split a communication channel into a set of subchannels of different bandwidth. Also the flexible algorithm architecture allows organizing data communication in particular subchannels that satisfy the requirement on Quality of Service (QoS). The proposed method is used in a system implementing a method of Data Transmission Oriented on the Object, Communication Media, Agents, and State of Communication Systems described in [1]. In that system, the proposed method is implemented for data analysis/synthesis, channel estimation/modeling, and datastream multiplexing/demultiplexing.

### BRIEF DESCRIPTION OF THE DRAWINGS

FIG. 5 are the elementary cells W₂ and V₂;

FIG. 6 is the Fast Fourier Transform (FFT) butterfly;

FIG. 7 is the scheme of the third level of the analysis-synthesis of the digital signal x[n];

FIG. 8 is the scheme of the W₄ cell as a combination of four elementary cells W₂;

FIG. 9 is the W₄ cell structure;

FIG. 10 is the W₈ cell structure;

### DETAILED DESCRIPTION OF THE INVENTION

Referring now to the invention in more detail.

### The Elementary Cell W₂

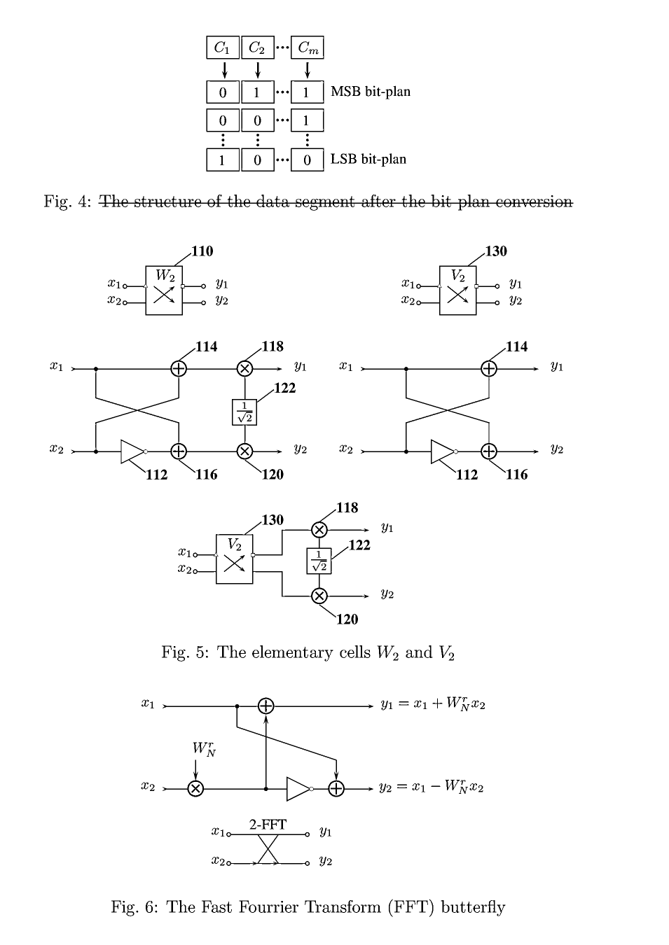

The core of the fast signal processing method is an elementary cell W₂ 110 and an elementary cell V₂ 130. They are shown on FIG. 5.

The elementary cell W₂ 110 consists of an inverter 112, an adder 114, an adder 116, a multiplier 118, a multiplier 120, and a block 122 generating a constant

$$\frac{1}{\sqrt{2}} .$$

The elementary cell V₂ 130 consists of the inverter 112, the adder 114, and the adder 116.

In other view, the elementary cell W₂ 110 consists of the elementary cell V₂ 130, a multiplier 118, a multiplier 118, and a block 122 generating a constant

$$\frac{1}{\sqrt{2}} .$$

The elementary cell W₂ 110 possesses a particular property which allows it to be used both for analysis and synthesis.

In case the elementary cell W₂ 110 is used for analysis of a digital signal x[n], odd samples of the signal x[2n−1] inputs to a pin x₁ and even samples of the signal x[2n] inputs to a pin x₂.

In case the elementary cell W₂ 110 is used for analysis of the digital signal x[n], the pin y₁ outputs the approximation signal

$$A [ k ] = \frac{1}{\sqrt{2}} ( x [ 2 n - 1 ] + x [ 2 n ] ) ,$$

and the pin y₂ outputs the detail signal

$$D [ k ] = \frac{1}{\sqrt{2}} ( x [ 2 n - 1 ] - x [ 2 n ] ) .$$

In case the elementary cell W₂ 110 is used for synthesis of the digital signal x[n], the approximation signal A[k] inputs to the pin x₁ and the detail signal D[k] inputs to the pin x₂.

In case the elementary cell W₂ 110 is used for synthesis of the digital signal x[n], the pin y₁ outputs the odd samples of the signal

$$x [ 2 n - 1 ] = \frac{1}{\sqrt{2}} ( A [ k ] + D [ k ] ) ,$$

and the pin y₂ outputs the even samples of the signal

$$x [ 2 n ] = \frac{1}{\sqrt{2}} ( A [ k ] - D [ k ] ) .$$

The assignments for Input/Output pins are presented in Table 1.

TABLE 1
Input/Output pin assignment of the fast elementary cell

| Input | Analysis | Synthesis | Output | Analysis | Synthesis |
|---|---|---|---|---|---|
| x₁ | x[2n − 1] | A[k] | y₁ | A[k] | x[2n − 1] |
| x₂ | x[2n] | D[k] | y₂ | D[k] | x[2n] |

Nowadays, the most common algorithm in Digital Signal Processing (DSP) is the Fast Fourier Transform (FFT). FIG. 6 shows is the two-point Fast Fourier Transform (FFT), or 2-FFT decimation-in-time butterfly.

The first advantage of the elementary cell W₂ 110 over 2-FFT is that the elementary cell W₂ 110 can be used for both data analysis and data synthesis.

The second advantage of the elementary cell W₂ 110 is that it's complexity is less than the one of the 2-FFT. The results are presented in Table 2. The complexity of an algorithm is measured by quantity of real adders (⊕), real multipliers ( [symbol] ) and real inverters (⊖). Use of the elementary cell W₂ 110 and the elementary cell V₂ 130 does not change the nature of input numbers, i.e. the real input numbers stay real. However, output of 2-FFT butterfly is always represented by complex numbers. Since, the 2-FFT butterly is applied more than ones, the input of the next stage 2-FFT operation will be complex, and there is no reason to consider the real input numbers for 2-FFT. Therefore the slot, corresponding to the number of operations on real input numbers, is empty in Table 2.

TABLE 2
Complexity of W₂, V₂ cells and 2-FFT
butterfly in terms of real operations

| Input numbers | W₂ | V₂ | 2-FFT |
|---|---|---|---|
| Real | 2 ⊕ + 2 [symbol] + 1⊖ | 2 ⊕ + 1⊖ | n/a |
| Complex | 4 ⊕ + 4 [symbol] + 2⊖ | 4 ⊕ + 2⊖ | 6 ⊕ + 4 [symbol] + 3⊖ |

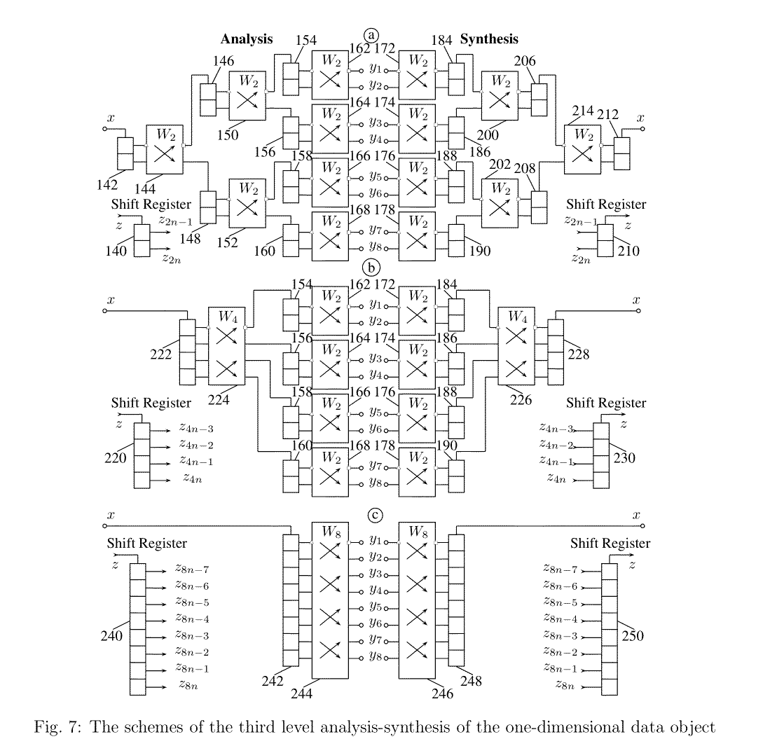

The elementary cell W₂ 110 outputs the approximation and detail features of the input signal. One might decide to continue the procedure by analysing the features of features etc. The decision of whether to proceed with further analysis is based on certain criteria. Signal analysis is stopped upon a certain parameter of feature segment is reached. FIG. 7 shows the schemes of the third level analysis-synthesis of the one-dimensional data object x[n].

### The W₄ and W₈ Cells

The elementary cell W₂ is used to build processing cells of higher orders, such as W₄ and W₈ cells. The scheme on FIG. 7a) is purely based on the elementary cells W₂ 110. The third level analysis scheme consists of seven elementary cells W₂ (144, 150, 152, 162, 164, 166, 168), and seven shift registers (142, 146, 148, 154, 156, 158, 160). The shift register 140, used in the analysis scheme, outputs two datastreams. The first datastream consists of the odd samples z₂ₙ₋₁ of the input datastream z. The second datastream consists of the even samples z₂ₙ of the input datastream z. The third level synthesis scheme consists of seven elementary cells W₂ (172, 174, 176, 178, 200, 202, 214), and seven shift registers (184, 186, 188, 190, 206, 208, 212). The shift register 210, used in the synthesis scheme, inputs two datastreams. The first datastream consists of the odd samples z₂ₙ₋₁ of the output datastream z. The second datastream consists of the even samples z₂ₙ of the output datastream z.

In case a computational platform possesses enough resources, the computational speed of the analysis-synthesis can be increased by applying parallel computing techniques instead of serial ones. The scheme on FIG. 7b) is based on the combination of the elementary cells W₂ 110 and W₄ cells. The third level analysis scheme consists of one cell 224, four elementary cells W₂ (162, 164, 166, 168), a four stage shift register 222, and four shift registers of type 140 (154, 156, 158, 160). The four stage shift register 220, used in the analysis scheme, outputs four datastreams. The four stage shift register 220 serves as a serial-to-parallel converter. The third level synthesis scheme consists of one W₄ cell 226, four elementary cells W₂ (172, 174, 176, 178), four shift registers of type 210 (184, 186, 188, 190), and a four stage shift register 230. The four stage shift register 230, used in the synthesis scheme, inputs four datastreams. The four stage shift register 230 serves as a parallel-to-serial converter.

In case a computational platform possesses even more resources, the computational speed of the analysis-synthesis can be increased even more. The scheme on FIG. 7c) is based on W₈ cells. The third level analysis scheme consists of one W₈ cell 244, and an eight stage shift register 242. The eight stage shift register 240, used in the analysis scheme, outputs eight datastreams. The four stage shift register 240 serves as a serial-to-parallel converter. The third level synthesis scheme consists of one W₈ cell 246, and an eight stage shift register 248. The eight stage shift register 250, used in the synthesis scheme, inputs eight datastreams. The eight stage shift register 250 serves as a parallel-to-serial converter.

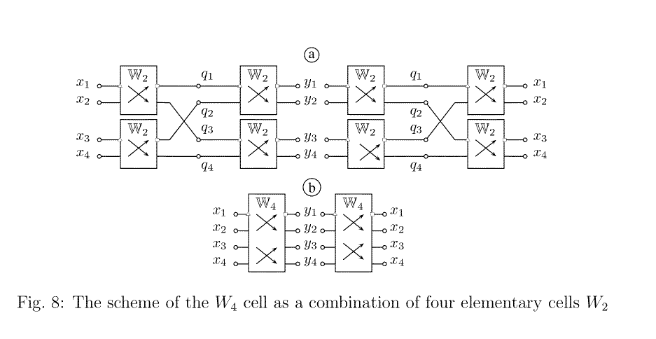

FIG. 8 shows the scheme of the W₄ cell as a combination of four elementary cells W₂.

The W₄ cell can be employed for analysis-synthesis of two-dimensional data object, or image. During analysis the W₄ cell transforms four image pixels (X[2n−1,2m−1], X[2n−1, 2m], X[2n, 2m−1], X[2n, 2m]) into an approximation (A[n,m]) coefficient, and three detail coefficients: horizontal (H[n,m]), vertical (V[n,m]) and diagonal (D[n,m]). During synthesis the W₄ cell transforms the approximation (A[n,m]) coefficient, and three detail coefficients: horizontal (H[n,m]), vertical (V[n,m]) and diagonal (D[n,m]) into four image pixels (X[2n−1, 2m−1], X[2n−1, 2m],X[2n, 2m−1], X[2n, 2m]). Where n=1 . . . N, m=1 . . . M, N×M is the image size. The assignments for Input/Output pins are presented in Table 3 for both cases of use the two-dimensional elementary cell in image analysis and synthesis.

TABLE 3
Input/Output pin assignment of the 2D fast elementary cell

| Input | Analysis | Synthesis | Output | Analysis | Synthesis |
|---|---|---|---|---|---|
| x₁ | X[2n − 1, 2m − 1] | A[n, m] | y₁ | A[n, m] | X[2n − 1, 2m − 1] |
| x₂ | X[2n − 1, 2m] | H[n, m] | y₂ | H[n, m] | X[2n − 1, 2m] |
| x₃ | X[2n, 2m −1] | V[n, m] | y₃ | V[n, m] | X[2n, 2m − 1] |
| x₄ | X[2n, 2m] | D[n, m] | y₄ | D[n, m] | X[2n, 2m] |

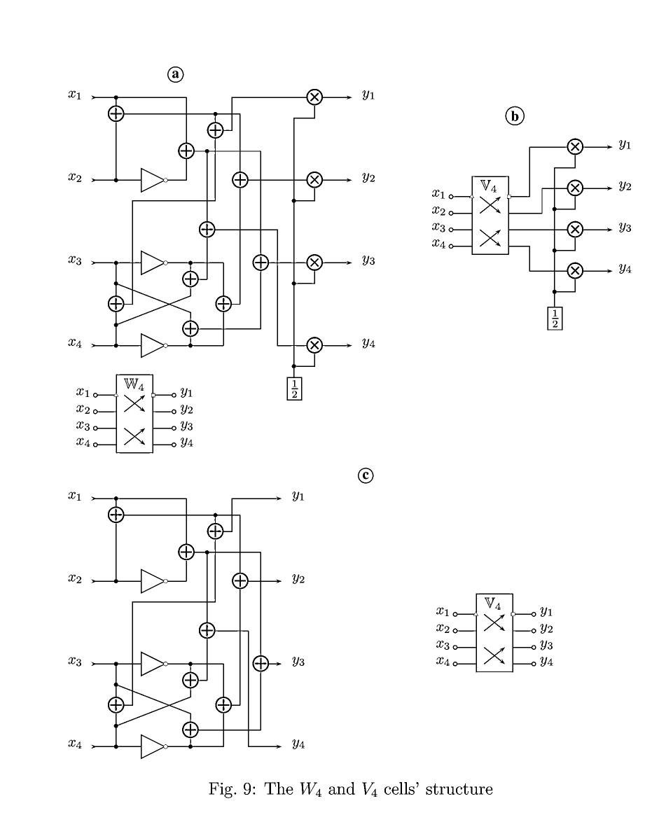

FIG. 9 shows the structure of the W₄ and V₄ cells as a combination inverters, adders, multipliers, and blocks generating a constant ½. Complexities W₄ and V₄ cells are presented in 4

TABLE 4
Complexity of W₄, V₄ cells in terms of real operations

| Input numbers | W₄ | V₄ |
|---|---|---|
| Real | 10 ⊕ + 4 [symbol] + 3⊖ | 10 ⊕ + 3⊖ |
| Complex | 20 ⊕ + 8 [symbol] + 10⊖ | 20 ⊕ + 6⊖ |

An operation of multiplication by ½ can be replaced by the shift operation. In that case no multiplication operations required in W₄.

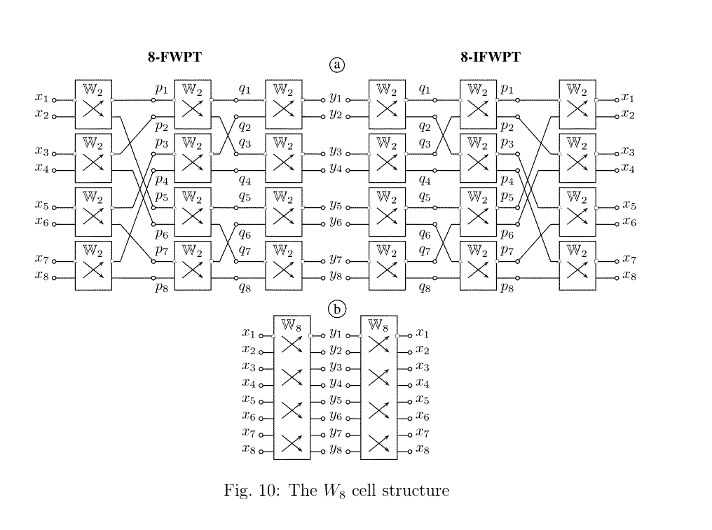

FIG. 10 shows the structure of the W₈ cell as a combination of the W₂ cells.

The W_{N} cell (N=2ⁿ, n ∈ Z)

Generally, the W_{N} cell (N=2ⁿ, n ∈ Z) can be build. It will be able to operate on data points simultaneously. An implementation of the W_{N} cell is limited by computational platform resources.

The complexity of W_{N} cell (N=2ⁿ, n ∈ Z) n comparison with the complexity of the N-point (FFT) is presented in Table 5.

The elementary cell W₂ 110 can be envisioned as the elementary cell V₂ 114 whose output is multiplied by

$$\frac{1}{\sqrt{2}} .$$

By analogy, the W_{N} can be envisioned as the V_{N} whose output is multiplied by

$${( \frac{1}{\sqrt{2}} )}^{d} = {2}^{- \frac{d}{2}} ,$$

where d=log₂N. In case d=2k is even, the multiplier

$${2}^{- \frac{d}{2}} = {2}^{- k}$$

can be replaced by the shift register. In case d=2k+1 is odd, the multiplier can be envisioned as the two multipliers

$${2}^{- \frac{2 k + 1}{2}} = {2}^{- k} \cdot \frac{1}{\sqrt{2}} .$$

Multiplication by 2^{-k} can be replaced by the shift register, however multiplication by

$$\frac{1}{\sqrt{2}}$$

should be implemented. Totally N multipliers by

$$\frac{1}{\sqrt{2}}$$

are required for W_{N} in case d=Log₂N is odd.

TABLE 5
Complexity of the N-point FWPT vs. the N-point FFT in terms
of real operations

| Input | | |
|---|---|---|
| numbers | W_{N} | FFT |
| Real | $\frac{N}{2} {log}_{2} N ( 2 ⊕ + 1 ⊖ ) + βN ⊗$ | n/a |
| Complex | $\frac{N}{2} {log}_{2} N ( 4 ⊕ + 2 ⊖ ) + 2 βN ⊗$ | $\frac{N}{2} {log}_{2} N ( 6 ⊕ + 4 ⊗ + 3 ⊖ )$ |
| | $where$ $β = \{ \begin{matrix}0 & if d = {log}_{2} N is even \\ 1 & if d = {log}_{2} N is odd\end{matrix}$ | |

$$\begin{matrix}Spectral Efficiency = \frac{Total Object Bits}{Transmitted Symbols} , & ( 1 ) \\ Complexity = \frac{Total Processing Operations}{Total Object Bits} , & ( 2 ) \\ Total Object Bits = N \cdot M \cdot bit \text{-} per \text{-} pixel . & ( 3 )\end{matrix}$$

(1)

(2).

Same W_{N} cell can be implemented for both multiplexing and demultiplexing of N=2ⁿ (n ∈ Z) datastreams. For multiplexing of N datastreams they should be applied to the inputs of the W_{N} cell. Outputs of the W_{N} cell are connected to the shift register of order N. Shift register 250 represents an example of the shift register of the order 8. The shift register of order N outputs a serial datastream. For demultiplexing, the serial datastream is applied to the input of the shift register of order N. Shift register 240 represents an example of the shift register of the order 8. The parallel outputs of the shift register of order N are connected to the inputs of W_{N} cell. The N outputs of the W_{N} cell represent N demultiplexed datastreams.

The W_{N} cell based multiplexing-demultiplexing can be implemented for communication channel estimation and modeling. N pilot signals multiplexed and sent over a communication channel allow to estimate a channel profile. According to that profile, the channel can be divided into subchannels of different bandwidth. Efficient data communication can be organized in particular subchannels that satisfy the requirement on Quality of Service (QoS).

The invention can be implemented in a form of software, firmware running on computing devices or a hardware.

While the invention has been shown and described with reference to certain preferred embodiments thereof, it will be understood by those skilled in the art that various changes in form and details may be made therein without departing from the spirit and scope of the invention as defined by the appended claims.

### References

[1] M. Sabelkin, “Method and apparatus for data transmission oriented on the object, communication media, agents, and state of communication systems,” patent application Ser. No. 13/090,608, filed on Apr. 21, 2011.

What is claimed:

1. A method for fast signal processing, comprising:
the acts, performed by an adder, of addition of the first input sample and the second input sample;
the acts, performed by a substructor, of substruction of said second input sample from said first input sample;
the acts, performed by a constant block, of producing a constant value which is equal to one divided by a square root of two;
the acts, performed by the first multiplier, of multiplication of an output value of said adder by said constant value;
the acts, performed by the second multiplier, of multiplication of an output value of said substructor by said constant value;
whereby said first multiplier outputs the first output sample and said second multiplier outputs the second output sample.

2. The method according to claim 1 for signal analysis, wherein:
said first input sample is represented by an odd sample of a signal;
said second input sample is represented by an even sample of said signal;
said first output represents a sample of approximation of said signal;
said second output represents a sample of details of said signal.

3. The method according to claim 1 for signal synthesis, wherein:
said first input sample is represented by a sample of approximation of said signal;
said second input sample is represented by a sample of details of said signal;
said first output represents an odd sample of a signal;
said second output represents an even sample of said signal.

4. A method for fast signal analysis comprising the acts performed by a plurality of blocks implementing the method according to claim 2, and connected in banks and in series.

5. A data analyzer implementing the method according to claim 4.

6. A method for fast signal synthesis comprising the acts performed by a plurality of blocks implementing the method according to claim 3, and connected in banks and in series.

7. A data synthesizer implementing the method according to claim 6.

8. A method for quality driven data object decomposition, comprising:
the acts, performed by the method according to claim 4, of data object decomposition into a set of data object features until certain criteria is reached;
the acts, performed by a quality assignment block, of assignment an error sensitivity descriptor to each one of said data object features;
whereby said data object is transformed into said set of data object features with different error sensitivity.

9. The method according to claim 6 for data multiplexing.

10. A datastream multiplexer implementing the method according to claim 9.

11. The method according to claim 4 for data demultiplexing.

12. A data demultiplexer implementing the method according to claim 11.

13. A method for channel estimation, comprising:
the acts, performed by a pilot generator in a transmitter, of generating pilot signals;
the acts, performed by the method according to claim 9, of multiplexing said pilot signals;
the acts, performed by the method according to claim 11 in a receiver, of demultiplexing of a received signal into received pilot signals;
the acts, performed by a pilot generator in said receiver, of generating pilot signals identical to said pilot signals in said transmitter;
whereby a channel profile is obtained by comparison of said pilot signals with said received pilot signals.

14. A communication channel estimator implementing the method according to claim 13.

15. A method for channel multiplexing, comprising:
the acts, performed by the method according to claim 13, of obtaining a channel profile;
the acts, performed by a channel analyzer, of estimating a probability of error for each subchannnel and identify subchannels unusable by certain reasons;
the acts, performed by a multiplex configurer, of configuration of blocks and interconnections of said blocks in the method according to claim 9;
whereby datastreams with more error sensitive data are mapped into subchannels with lower probability of error.

16. A communication channel multiplexer implementing the method according to claim 15.
